(19) United States
(12) Patent Application Publication
(10) Pub. No.: US 2002/0194088 A1
(43) Pub. Date: Dec. 19, 2002

(54) Coupon book on-line customizing and ordering system

(75) Inventors: Samuel A. Sheddan, Clinton, TN (US); Michael S. Ward, Knoxville, TN (US)

Correspondence Address: PITTS AND BRITTIAN P C, P O BOX 51295, KNOXVILLE, TN, 37950-1295, US

(73) Assignee: WeDo Fundraising, Inc., Knoxville, TN

(21) Appl. No.: 10/213,955

(22) Filed: Aug. 6, 2002

(51) Int. Cl. G06F 17/60

(52) U.S. Cl. 705/26

(57) ABSTRACT

A coupon book system including a process and apparatus for customizing and ordering fundraising coupon books from an on-line client. Another embodiment of the coupon book system also includes the steps for merchant sponsoring, in which the merchant can make coupons available for inclusion in the coupon books. In still another embodiment, the coupon book system also includes the steps for the purchaser to order coupon books and other merchandise. The system includes a server and software for communicating with a client and for storing and processing data received from the client.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention relates to an apparatus, method, and system for manufacturing coupon books. More particularly, this invention pertains to customized coupon books, which are customized by users accessing a computer network.

2. Description of the Related Art

Selling coupon books is a popular fundraising method employed by schools and other organizations. A coupon book is a collection of coupons, typically for use within a specified geographical region. The organization sells the coupon books, keeping the profits for their fundraising efforts. Merchants sponsor the organization selling the books by offering coupons that are redeemable for discounts or gifts of merchandise or services. Examples of coupon offers include, but are not limited to, a free appetizer with a purchase of an entree, a percentage off the price of a purchase, a fixed dollar amount off the purchase price if the price is over a minimum value, offers to buy one item and get another free or at a reduced price, and free drinks or other items.

Schools engage in fundraising efforts to finance programs for which insufficient funds are otherwise available. A popular fundraising program includes selling coupon books. In this program, the students sell the coupon books to family, friends, and neighbors. The students are offered incentives for selling the coupon books, oftentimes involving awards of money or merchandise with the value of the award based on total sales by the student.

In order to maximize the fundraising efforts of the schools and other organizations, it is desirable to minimize the expense of producing the coupon books and to maximize the perceived value of the coupon books to the purchasing public. It is also desirable to reduce the fixed expenses for producing the coupon books such that smaller schools and organizations can benefit from selling a lesser number of coupon books than large schools or school systems.

### BRIEF SUMMARY OF THE INVENTION

According to one embodiment of the present invention, a system for customizing coupon books is provided. The system includes the method and apparatus for ordering customized coupon books. Participants in coupon book fundraising sales interactively customize the coupon book desired to be ordered. The coupon book order is then printed and delivered to the participant.

Another embodiment includes provisions for merchants to add coupons to a database. These coupons are then available for selection by the participants when customizing their coupon books. A still another embodiment includes provisions for purchasing coupon books and other merchandise after a participant has created a coupon book.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of an apparatus suitable for implementing the system;

FIG. 2 is a block diagram of a system for catering to three types of users;

FIG. 3 is a block diagram of the steps for a participant to order a customized coupon book;

FIG. 4 is a block diagram of the steps for a participant to customizing a coupon book;

FIG. 5 is a block diagram of the steps for a participant to modify a saved coupon book;

FIG. 6 is a block diagram of the steps for a merchant to sponsor a coupon;

FIG. 7 is a block diagram of the steps for a purchaser to buy merchandise; and

FIG. 8 is a pictorial representation of one embodiment of the database.

### DETAILED DESCRIPTION OF THE INVENTION

An apparatus, method, and system for customizing coupon books is disclosed. A coupon book is a bound collection of coupons. Each coupon identifies a sponsor and is redeemable for a discount or merchandise. Each coupon book is offered for sale by a participant.

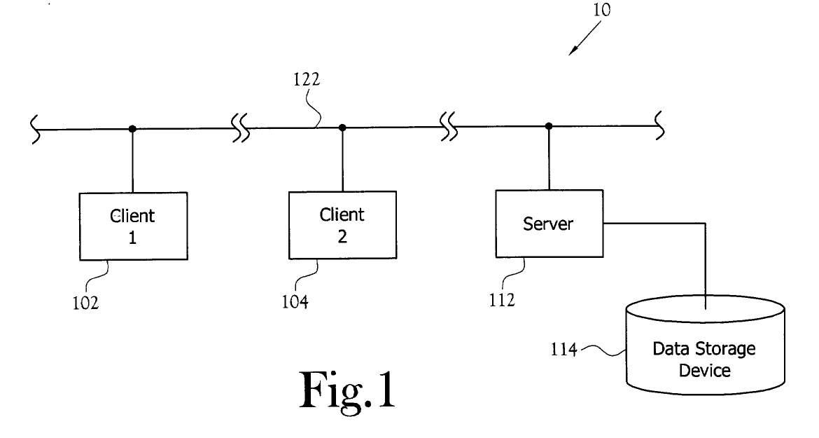

FIG. 1 is a block diagram illustrating an on-line computer system 10 including a computer communication network 122 with a first client 102, a second client 104, and a server 112 in communication with the network 122. The network 122 can be a widely based network such as the Internet, it can be a LAN, a local area network connecting a small group of computers, or it can be a WAN, a wide area network connecting multiple LANs. It is the nature of the computer communication network 122 to connect multiple clients 102 and 104, or workstations, to one or more servers 112. Those skilled in the art will recognize that although only two clients 102 and 104 are illustrated, any number of clients can be connected to the network 112 without departing from the spirit and scope of the present invention. In one embodiment, the network 122 is the Internet, the server 112 is a computer running web server software, and the client 102 is a computer running web browser software accessing the server 112 over the Internet 122.

Also shown in FIG. 1 is a data storage device 114, which includes a database containing tables storing the data related to the on-line computer system 10. The data storage device 114 is in communication with the server 112, and the data storage device 114 can be any of various devices known in the art for storing data, such as, but not limited to, a hard disk, a network attached storage device (NAS), recordable optical disks, and a stand-alone networked data storage device. Although FIG. 1 illustrates the data storage device 114 communicating directly with the server 112, in another embodiment, the data storage device 114 can be connected to the network 122 and communicate with the server 112 via the network 122.

Further, as used herein, a “client” should be broadly construed to mean any computer or component thereof directly or indirectly connected or connectable in any known or later-developed manner to a computer network, such as the Internet. Examples of a client include, but are not limited to, a personal computer, a terminal that communicates over the Internet, and an Internet connected television. The term “server” should also be broadly construed to mean a computer, computer platform, an adjunct to a computer or platform, or any component thereof. Of course, a client should be broadly construed to mean the equipment that requests or gets a file or information, and a server is the equipment that provides the file or information. These terms are based on the function of the associated equipment and the terms may interchange as the function of a particular piece of equipment changes.

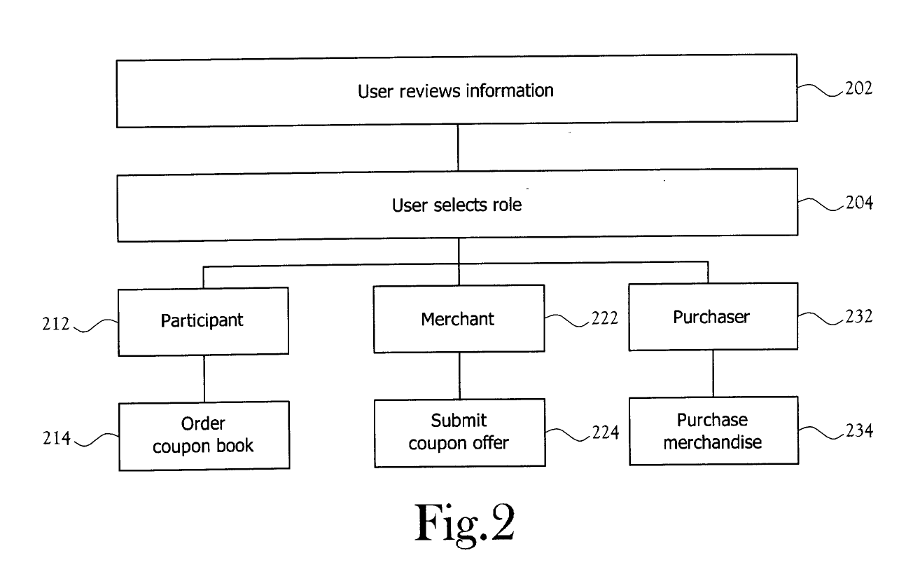

FIG. 2 shows a block diagram illustrating the decisions facing a user when accessing the custom coupon book system from a client 102. The user can view 202 the information stored on the server 112 and select 204 the role that the user wishes to play, that is, whether the user desires to be a participant 212 and place an order for coupon books to sell 214, to be a merchant 222 and submit a coupon for inclusion in a coupon book 224, or to be a purchaser 232 and purchase a coupon book 234 or other merchandise related to a participant. As used herein, a participant is a person or entity who wishes to obtain a quantity of coupon books for resale. For example, a school selling coupon books to raise funds is a participant. A merchant is a person or entity who wishes to offer a coupon to the public by having it included in a coupon book. For example, a restaurant offering a coupon good for a reduced price on a meal is a merchant. A purchaser is a member of the public who wishes to purchase either an individual coupon book or other merchandise to benefit a participant. For example, a parent of a student attending a school that is a participant would be a purchaser if the parent buys a coupon book or other school related merchandise. As part of the participant's fundraising activities, the participant can offer for sale items such as T-shirts, stadium seats, or other items associated with the participant. These items would be offered in addition to the coupon books offered by the participant.

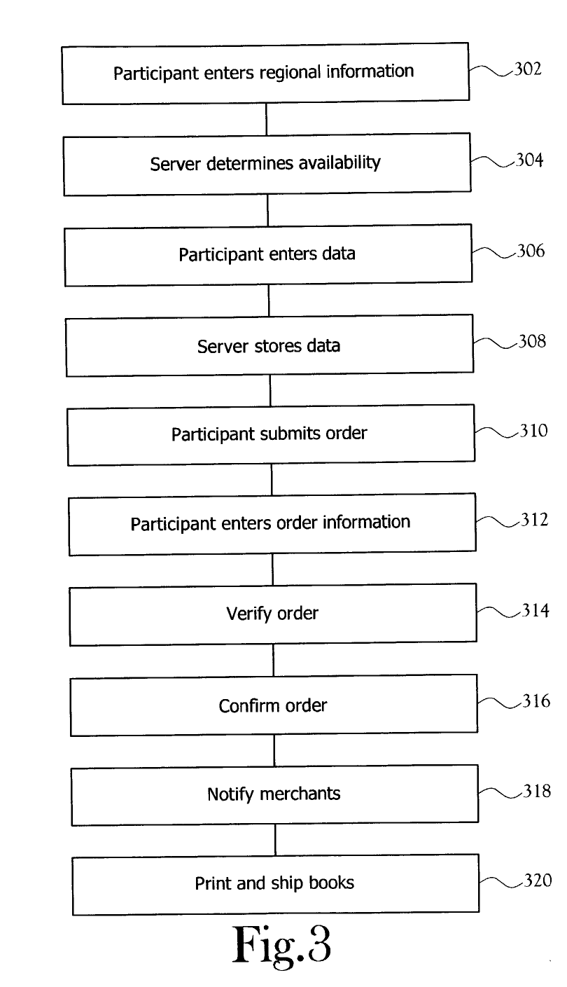

FIG. 3 shows a block diagram of the steps for a participant to order a customized coupon book. While accessing the server 112 from the client 102, the participant enters regional information 302. The regional information, in one embodiment, includes the participant's postal ZIP code. In another embodiment, the participant enters an address. The server 112 uses the participant's information to determine the availability of the coupon book program and individual coupons for the participant's area 304. After the server 112 determines availability 304, the participant enters data for ordering the coupon books 306 and the server 112 stores the data 308. This data includes the number of coupon books desired and the specific coupons to include in the completed book.

After the participant views the specifics of the customized coupon book on the client 102, the participant submits the order 310 to the server 122 and enters the information needed to complete the order 312, such as the billing and shipping information. The order is then verified 314. In one embodiment, the participant is personally contacted, off-line, to verify that the user placing the order has authorization to place the order for the organization. The participant is contacted via telephone, postal mail, by an in-person visit, or other means of verification can be employed, such as contacting the participating organization or a financial institution that can provide verification. The order for the coupon books is confirmed 316. In one embodiment, the confirmation 316 is performed at the same time and in the same manner as the verification 314. In another embodiment, the confirmation 316 is made via an electronic message sent to the participant. After confirmation 316, the merchants are notified 318 that their coupons are being included in a coupon book. In one embodiment, the notification 318 is via an electronic message sent to the merchant.

After confirmation 316 of the order, the coupon book order is fulfilled 320; that is, the coupon books are printed and shipped to the participant. In one embodiment, the server 112 communicates the order information to a computerized printing press that prints the coupon books. In one embodiment, the server 112 communicates the shipping information to automate shipping the coupon books to the participant.

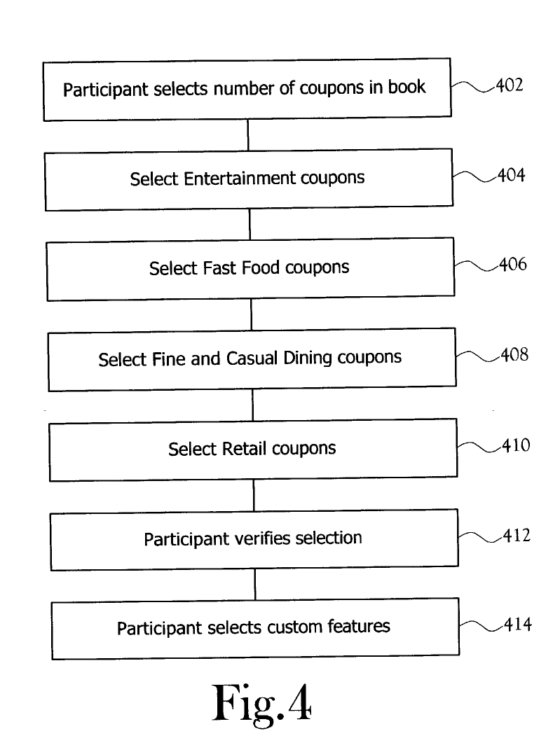

FIG. 4 shows a block diagram of the steps for customizing a coupon book, which steps are shown on FIG. 3 as the participant entering data 306 and the server 112 storing the data 308. The selection steps 402, 404, 406, 408, 410 shown in FIG. 4 can be performed in any order. The participant selects the number of coupons to be in the coupon book 402. The server 112 stores this data. In one embodiment, the available coupons are divided into four categories: entertainment, fast food, fine and casual dining, and retail, also called shopping, which includes merchandise offered for sale, whether at list price or at a discount. The server 112 permits the client 102 to display only those coupons for each category that are available in the geographical region associated with the participant. The participant selects from the available coupons for each category, as desired. After making selections, the participant verifies the selections 412. In one embodiment, the server 112 permits the client 102 to display the selected coupons for verification by the participant 412. In another embodiment, the participant has the option to save the selections for future editing and ordering.

In one embodiment, the participant selects custom features 414 that distinguish the participant's coupon books from others with which the participant may be competing. In one embodiment, the participant selects the cover graphics and design. In another embodiment, the participant selects the design of the coupons in the book. The design features include the base color of the coupon.

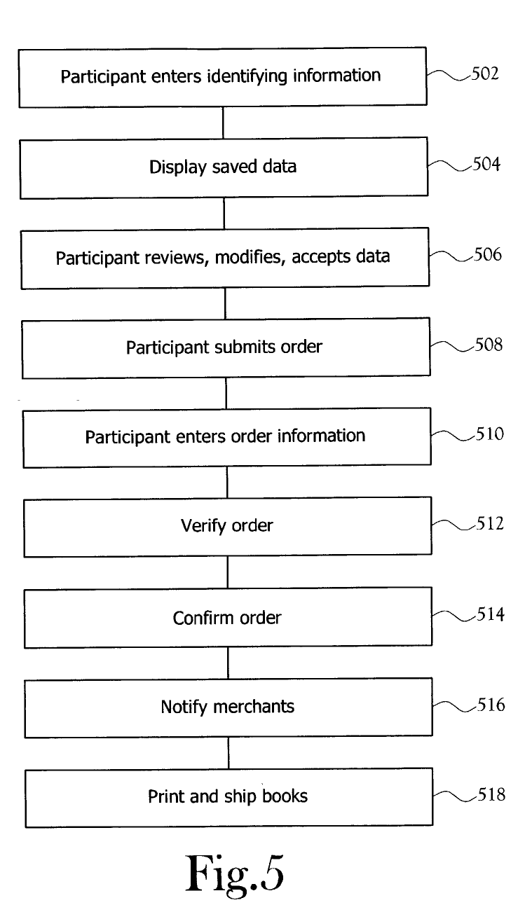

FIG. 5 shows a block diagram of the steps for a participant to modify the data related to a saved coupon book. In one embodiment, the participant has the option to save the coupon book data instead of submitting an order 310. In this embodiment, the participant recalls the stored data from the server 112 and continues the ordering process by first entering identifying information 502 at the client 102. The saved data is displayed 504 and the participant reviews, modifies, and/or accepts the data 506. After accepting the data 506, the participant submits the order 508 and enters any necessary ordering and shipping information 510, after which the order is verified 512 and confirmed 514. The merchants are notified 516 and the coupon books are printed and shipped 518. In one embodiment, the steps following the participant's acceptance of the data 506 are the same steps as beginning with submitting the order 310 shown on FIG. 3.

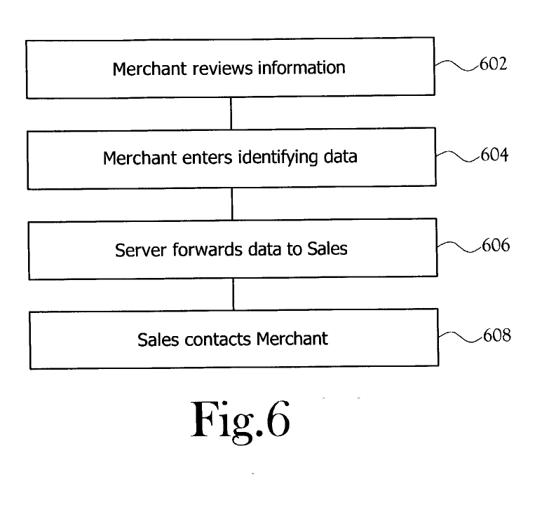

FIG. 6 shows a block diagram of the steps for a merchant to sponsor a coupon. In one embodiment, merchants can request that coupons be made available for inclusion in coupon books for a specified geographical region. From the client 102, the merchant reviews the information 602 stored on the server 112 describing the various regions available for distributing coupon books. The merchant enters identifying data 604 at the client 102, and the data is saved on the server 112. The server 112 forwards the data to a sales person 606, who then contacts the merchant 608.

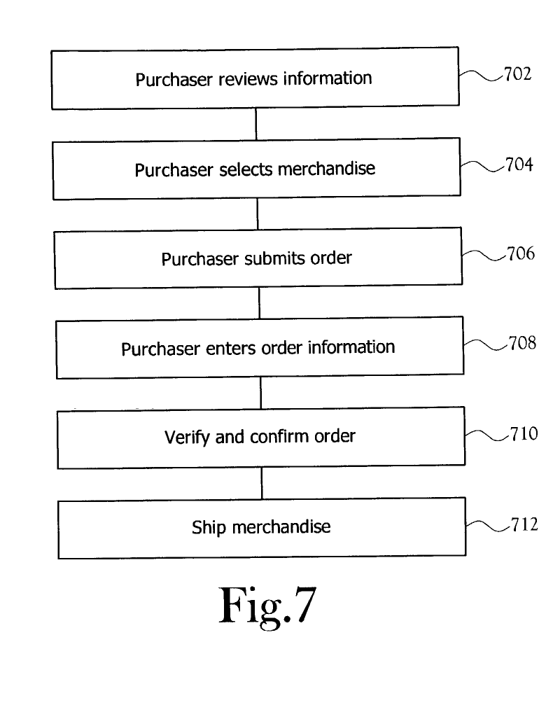

FIG. 7 shows a block diagram of the steps for a purchaser to buy merchandise, including a coupon book. In one embodiment, purchasers can purchase coupon books or other merchandise through the client 102 after the purchaser enters information at the client that identifies the participant and the server 112 determines what merchandise is available for purchase. From the client 102, the purchaser enters data identifying the participant and reviews the information 702 stored on the server 112 describing the merchandise available for purchase from that participant. In one embodiment, the merchandise includes coupon books. In another embodiment, the merchandise includes participant related items. The purchaser selects the merchandise to order 704 and submits an order 706. After the purchaser enters the ordering, billing, and shipping information 708, the order is verified and confirmed 710. The merchandise is then shipped 712.

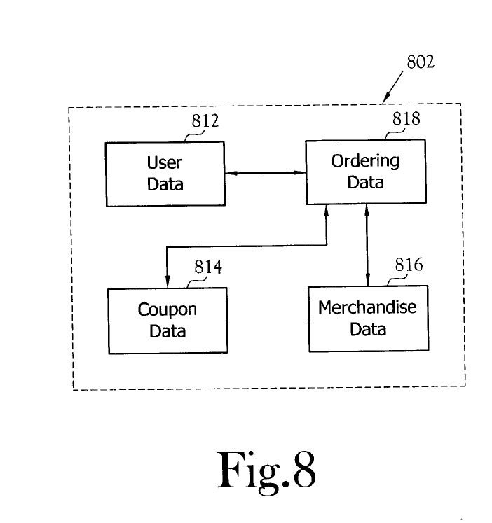

FIG. 8 illustrates the database 802 contained in the data storage device 114. The database 802 includes user data 812, coupon data 814, merchandise data 816, and ordering data 818. These four data collections 812, 814, 816, 818 are related such that data need only be stored once, but can be easily referenced as needed. In one embodiment, user data 812 has several related tables for storing user information. For example, there is a table containing user information, such as name and system log on ID and password, a related table for address information, a related table for phone numbers, and a related table for organization, such as the name of the school or merchant. The coupon data 814 includes tables storing coupon information such as area the coupon is available, the organization (merchant) offering the coupon, and the specifics of the coupon offer. An example of one of the relations between the coupon data 814 and the user data 812 is that the coupon data 814 stores only a link to the merchant information stored in the user data 812. The merchandise data 816 includes related tables storing merchandise information such as description, quantity available, and price. The ordering data 818 includes related tables storing information such as date the order was placed, who placed the order, shipping information, and the coupons and merchandise ordered.

Referring to FIG. 1, the server 112 includes a processor for executing software routines, data storage for storing software and data, and communications hardware for communicating with the network 122. The server 112 communicates with the data storage device 114, which includes a database 802 containing information on the coupons available within specific regions and containing information entered from a client 102, for example, information entered by a participant from a client 102 with respect to a coupon book. The database 802 also contains participant, merchant, and purchaser data, including the data and information entered by each at a client 102. The server 112 includes software for saving data to the database 802 and for retrieving data from, or querying, the database 802.

In one embodiment, the server 112 executes web server software, which is software for communicating over a network with clients using HTTP (hypertext transfer protocol). Web server software responds to requests from a client 102 and provides a service to the client 102. The client 102 runs browser software that communicates with the server 112 running web server software. Browser software is readily available and well known among those skilled in the art.

The server 112 also executes other software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. In one embodiment, these routines' and functions include CGI (common gateway interface) programs or script for generating dynamic content to be displayed at a client 102. In another embodiment, these routines and functions include code written using Microsoft NET technology, which includes ASP, XML/XSL, and custom server-side components. As used herein, software and routines are synonymous; however, in general, a routine refers to code that performs a specified function, whereas software is a more general term that may include more than one routine or perform more than one function.

For a participant to enter regional information 302, the server 112 includes software for sending information for displaying on the client 102. The software monitors for information, such as regional information 302, entered at the client 102, and processes any information returned from the client 102. In one embodiment, regional and coupon information is stored in a database 802. In this case, the software processes the regional information by querying the database 802 to determine which coupons are available in the participant's region 304. In one embodiment, the regional information entered by the participant is a postal ZIP code, and the software first processes the ZIP code to determine a geographical region and then processes the geographical region information to determine which coupons are available.

The server 112 includes a routine for providing an interface for the participant at the client 102 to interact with the server 112 for viewing the coupons available in the participant's region and for selecting coupons to be included in a coupon book 306. The software permits the participant to verify the coupons selected 412 and stores information on the selected coupons 308. In one embodiment, the software queries the participant for the total number of coupons to be included in the coupon book 402, and the software processes this number to ensure that the proper number of coupons are selected for inclusion. In another embodiment, the software presents the available coupons at the client 102 arranged in groups. The groups include entertainment, fast food, fine and casual dining, and retail, which includes merchandise offered for sale. In this embodiment, the participant selects the coupons to be included from each of the groups. In still another embodiment, the software provides for the participant to select custom features of the coupon book 414.

In one embodiment, the software provides for ordering the customized coupon book. Information is saved, or stored, in the database 802, which allows the participant to temporarily stop the data entry process and return to it at a later time.

The software provides an interface for the participant at the client 102 to interact with the server 112 for submitting an order 310, which includes the participant entering billing and shipping information at the client 102. The software processes the order by storing the information, verifying the order information 314, confirming the order 316, and notifying each merchant sponsoring-a selected coupon 318. In one embodiment, the software verifies the order information 314 by sending the order information to an operator who contacts the participant to verify the order. In another embodiment, the software confirms the order 316 by sending an electronic message (e-mail) to the participant. In still another embodiment, the software notifies the merchant 318 by sending an e-mail to the merchant.

In one embodiment, a routine communicates with a printing press or a printer for printing the coupon books 320. In still another embodiment, a routine provides shipping information for the printed coupon books 320.

The participant, in one embodiment, has the capability to save the information entered at the client 102 and resume data entry and ordering at a later time. This embodiment includes software for the participant to enter identifying information 502 at the client 102 and for the server 112 to retrieve stored data for displaying 504 at the client 102. The software provides an interface for the participant at the client 102 to interact with the server 112 for reviewing, modifying, and accepting the data 506. After accepting the data 506, the software provides an interface for the participant at the client 102 to interact with the server 112 for submitting an order 508, in which case the software performs the ordering functions described above.

In one embodiment, the merchant has the capability of sponsoring a coupon. The software provides an interface for the merchant at the client 102 to interact with the server 112 for reviewing the information relating to the coupon book program 602. The software processes the identifying data entered by the merchant 604 and forwards the data to sales 606, who then contacts the merchant to arrange sponsoring 608.

In one embodiment, the purchaser has the capability of purchasing merchandise, including coupon books and participant related items, that the server 112 determines are available for the participant relevant to the purchaser. The software provides an interface for the purchaser at the client 102 to interact with the server 112 for identifying the participant and reviewing the information 702 stored on the server 112, for selecting the merchandise to purchase 704, and for submitting an order 706, along with the ordering information 708. The software processes the order by storing the information and by verifying and confirming the order information 710.

The inventive mechanism is implemented within at least one server. Thus, the invention does not require any modifications to conventional client machine hardware or software. Although not meant to be limiting, the above-described functionality is preferably implemented as standalone native code. Generalizing, the above-described functionality is implemented in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network.

In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

From the foregoing description, it will be recognized by those skilled in the art that a coupon book system, including a method and apparatus, has been provided. In one embodiment, the coupon book system is a process that includes the steps for participant customizing and ordering the coupon books. In another embodiment, the coupon book system also includes the steps for merchant sponsoring. In still another embodiment, the coupon book system also includes the steps for the purchaser to order coupon books and other merchandise. The coupon book system includes a server running software communicating with a client. The software also stores and processes the data received from a client.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A method for customizing and ordering coupon books on-line, said method comprising the steps of:
a) entering regional information at a client by a participant;
b) displaying a plurality of regional specific coupon information at said client;
c) selecting a plurality of coupons to include in a plurality of coupon books at said client by said participant;
d) ordering said plurality of coupon books at said client by said participant;
e) printing said plurality of coupon books; and
f) delivering said plurality of coupon books.

2. The method of claim 1 wherein said step of ordering said plurality of coupon books includes the steps of:
submitting an order for said plurality of coupon books at said client by said participant;
entering order information at said client at said client by said participant; and
confirming said order with said participant.

3. The method of claim 2 wherein said step of ordering said plurality of coupon books includes the step of verifying said ordering information.

4. The method of claim 1 further including a step of selecting at least one custom feature of said plurality of coupon books at said client by said participant.

5. The method of claim 1 further including a step of notifying a merchant that has a coupon included in said plurality of coupon books, said step of notifying being performed after said step of ordering said plurality of coupon books.

6. The method of claim 1 further including said steps of:
entering identifying information at second client by a merchant;
forwarding said identifying information to a salesperson; and
contacting said merchant to obtain sponsor information.

7. The method of claim 1 further including said steps of:
reviewing information at a third client by a purchaser;
selecting merchandise at said third client by said purchaser;
submitting an order for said selected merchandise at said third client by said purchaser;
entering ordering information at said third client by said purchaser;
verifying said ordering information; and
shipping said order.

8. A method for customizing and ordering coupon books on-line, said method comprising the steps of:
a) entering regional information at a client;
b) displaying a plurality of regional specific coupon information at said client;
c) selecting a plurality of coupons to include in a plurality of coupon books at said client;
d) submitting an order for said plurality of coupon books at said client;
e) entering order information at said client at said client; and
f) confirming said order;
g) printing said plurality of coupon books; and
h) delivering said plurality of coupon books.

9. A method for offering coupon books on-line, said method comprising the steps of:
a) at a first client, having a participant enter regional information;
b) at said first client, displaying a plurality of regional specific coupon information;
c) at said first client, having said participant select at least one coupon for inclusion in a plurality of coupon books;
b) at said first client, having said participant submit a participant order for said plurality of coupon books;
c) printing said plurality of coupon books after said step of having said participant submit said participant order;
d) delivering said plurality of coupon books after said step of printing said plurality of coupon books;
e) at a second client, having a merchant request making available of at least one coupon;
e) at a third client, having a purchaser review information;
f) at said third client, having said purchaser select merchandise;
g) at said third client, having said purchaser submit a purchaser order; and
h) shipping said selected merchandise.

10. A server connectable to a computer network having at least one client, said server comprising:
a data storage device;
a database stored in said data storage device; and
a processor for executing a software program; said software program including
a routine for communicating with a client,
a routine for interacting with said participant at said client,
a routine for processing regional information entered by said participant at said client,
a routine for sending coupon information from said database to said client, said coupon information being specific to a region specified by said participant,
a routine for processing selections from said participant, said selections reflecting at least one coupon selected for inclusion in a coupon book, and
an ordering routine for processing an order by said participant.

11. The server of claim 10 wherein said software program further includes a routine for storing and retrieving data from said database.

12. The server of claim 10 wherein said software program further includes a routine interacting with said client for a merchant to request sponsorship.

13. The server of claim 10 wherein said software program further includes a routine interacting with said client for a purchaser to purchase merchandise.

14. A server connectable to a computer network having at least one client, said server comprising:
a means for communicating with a client;
a means for obtaining regional information from a participant at said client;
a means for sending coupon information relating to a specified region to said client;
a means for interacting with said client for selecting at least one coupon for inclusion in a plurality of coupon books;
a means for processing data received from said client;
a means for submitting an order for said plurality of coupon books; and
a means for processing said order.
